(19) United States
(12) Patent Application Publication
(10) Pub. No.: US 2005/0110938 A1
(43) Pub. Date: May 26, 2005

(54) Liquid crystal dispaly panel

(76) Inventor: Long-Hai Wu, Bade City (TW)

Correspondence Address: HARNESS, DICKEY & PIERCE, P.L.C., P.O. BOX 8910, RESTON, VA, 20195, US

(21) Appl. No.: 10/947,190

(22) Filed: Sep. 23, 2004

(30) Foreign Application Priority Data
Nov. 25, 2003 (TW) 092133108

(51) Int. Cl. G02F 1/1333

(52) U.S. Cl. 349/158

(57) ABSTRACT

A wide-viewing-angle liquid crystal display panel is provided. The wide-viewing-angle liquid crystal display panel includes a first wide-viewing-angle substrate having a first surface and a second surface, a first alignment film mounted on the first surface, a first polarizer mounted on the second surface, a second wide-viewing-angle substrate having a third surface and a fourth surface, a second alignment film mounted on the third surface, a second polarizer mounted on the fourth surface, and a liquid crystal layer, wherein the first wide-viewing-angle substrate and the second wide-viewing-angle substrate are so positioned that the first surface is near the third surface than the second surface, and the liquid crystal layer is placed therebetween.

### FIELD OF THE INVENTION

The present invention relates to a liquid crystal display panel, and more particularly to a wide-viewing-angle liquid crystal display panel.

### BACKGROUND OF THE INVENTION

The active thin film transistor (TFT) is the control elements for actively controlling the light flux of each individual pixel. The principle of the image generation is that each individual pixel is able to show the desired color on the panel. To achieve this purpose, a back light is used which is normally formed by a number of fluorescent lamps. In order to light a single pixel, the panel should be divided into a number of ‘shutters’ or ‘doors’ to let the light pass through. The liquid crystal display (LCD) stands for the display based on liquid crystals. The molecular structures of the liquid crystal could be changed and therefore varying levels of light are able to pass through them (or the light could be blocked completely). How much light will be allowed to pass and which colors are created are determined exactly by two polarizers, color filters and two alignment layers included in the LCD. All the layers are positioned between two glass substrates. A specific voltage is applied to the alignment film for creating an electric field which aligns the liquid crystals. Each pixel on the screen is composed of three subpixels (red, green and blue) which is similar to that in the cathode ray tube devices.

At present, the most common LCD device is Twisted Nematic TFT (TFT-TN). When no voltage is applied to the subpixels by the transistor, the liquid crystals (and the polarized light controlled thereby) between the two substrates are twisted horizontally by 90 degrees. The polarizer of the second substrate is shifted by 90 degrees corresponding to that of the first substrate so that the light could pass through it. If the red, green and blue subpixels could be lighted sufficiently, a white pixel would be produced on the frame by mixing the three subpixels. When a voltage is applied to the ITO, which means a vertical electric field is created, the spiral structures of the liquid crystals would be destroyed, and the liquid crystals are twisted to aligne in the direction of the electric field. That means the liquid crystals will be vertical to the polarizer of the second substrate finally. The polarized light could not pass through the subpixels. A white pixel would become a black pixel and the whole frame would be black.

When comparing the TFT-TN display with the conventional cathode ray tube monitor, TFT-TN display has some decisive disadvantages. One of them is a problem about viewing angle. When viewing a TFT-TN display from the side, a dramatic loss of screen brightness and a characteristic change of displayed colors would be easily noticed. Older TFT-TN display typically has a viewing angle of 90 degrees, i.e. 45 degrees to left and right sides respectively. Accordingly, the viewing angle is a problem which the LCD manufacturers always desire to overcome.

Nowadays, the most important technologies available for the wide-viewing-angle LCD are TN+Film, Multi-Domain Verticle Alignment (MVA) and In-Plane Switching (IPS). MVA and IPS technologies are more complicated due to the processes they involved. TN+Film solution is the simplest way to implement because only a retardation or discotic film is applied to the conventional TFT-TN display. Besides, the TN+Film technology is definitely the most inexpensive and the manufacturing yield rate is relatively high. Accordingly, the market share of the wide-viewing-angle LCD manufactured by TN+Film technology is about 80%.

Please refer to FIG. 1, which is a diagram showing the structure of the LCD panel manufactured by TN+Film technology according to the prior art. The wide-viewing-angle LCD panel includes the first transparent substrate 11, the second transparent substrate 12, the liquid crystal layer 13, the first retardation film 14 and the second retardation film 15. The liquid crystal layer 13 is placed between the first transparent substrate 11 and the second transparent substrate 12. The first retardation film 14 is mounted on the outside of the first transparent substrate 11 and the second retardation film 15 is mounted on the outside of the second transparent substrate 12. The LCD panel further includes the first polarizer 16 and the second polarizer 17. The first polarizer 16 is mounted on the outside of the retardation film 14 and the second polarizer 17 is mounted on the outside of the retardation film 15. The LCD panel further includes the first alignment film 18 and the second alignment film 19. The first alignment film 18 is mounted on the inside of the first transparent substrate 11 and the second alignment film 19 is mounted on the inside of the second transparent substrate 12. The first transparent substrate 11 and the second transparent substrate 12 are typically made of the glass substrates or plastic substrates without extensibility. The first polarizer 16 and the second polarizer 17 are typically made by respectively mounting a triacetyl-cellulose (TAC) film on both side of a polyvinyl alcohol (PVA) film. The first and the second retardation films 14, 15 are used for improving the viewing angle of the LCD panel, and the horizontal viewing angle would be improved from about 90 degrees to approximately 140 degrees. Therefore, the retardation film, i.e. the Wide View Film (WVF) is a key component for the LCD manufacturing market. The bright/dark effect of the LCD is performanced by the property of the liquid crystal, which is between the solid and liquid properties, and the optical characteristic provided by collocating the liquid crystals collocating with the optical thin films. Therefore, the display quality would be influenced by the collocation of each kind of the optical thin film. However, the retardation film for improving the viewing angle is only provided by FujiFilm. Fujifilm provides the polarizer manufacturing factories with the retardation films. Then the factories mount the retardation films on the polarizers and provide them to the TFT-LCD manufacturing factories. The cost of the polarizer with the retardation film is 2 to 3 times than that of the polarizer without the retardation film. Not only the cost would be raised, but also the manufacturing time would be extended. Besides, the manufacturing yield rate would be lowered when combining products provided by different factories because the quality of the polarizer with the retardation film provided by different polarizer manufacturing factory is not uniform.

Hence, it is known that a liquid crystal display panel having wide-viewing-angle substrates for overcoming the drawbacks in the prior art is needed.

### SUMMARY OF THE INVENTION

It is an object of the present invention to provide a liquid crystal display panel. The wide-viewing-angle substrate of the liquid crystal display panel of the present invention is not only provided with the function as the retardation film, but also is provided for lowering the thickness, the weight, the cost of the panel and overcoming the problem of the low yield rate generated in the mounting process of the retardation film. Because of lowering the thickness of the panel, which results in the shorter transmisson distance and the less loss of the light, the image quality of the LCD would be improved.

In accordance with one aspect of the present invention, a liquid crystal display panel is provided. The liquid crystal display panel includes a first wide-viewing-angle substrate having a first surface and a second surface, a first alignment film mounted on the first surface, a first polarizer mounted on the second surface, a second wide-viewing-angle substrate having a third surface and a fourth surface, a second alignment film mounted on the third surface, a second polarizer mounted on the fourth surface, and a liquid crystal layer, wherein the first wide-viewing-angle substrate and the second wide-viewing-angle substrate are so positioned that the first surface is near the third surface than the second surface, and the liquid crystal layer is placed therebetween.

Preferably, the first and the second wide-viewing-angle substrates are flexible plastic substrates with extendable and wide-viewing-angle effects.

Preferably, the first and the second wide-viewing-angle substrates are wide-viewing-angle substrates with double optical axes, respectively.

Preferably, the wide-viewing-angle substrate with double optical axes further comprises an in-plan retardation value (Ro) and an out-of-plan retardation value (Rth).

Preferably, Ro is ranged between 0 and 400 nm.

Preferably, Rth is ranged between 0 and 300 nm.

Preferably, the wide-viewing-angle substrate with double optical axes is an anisotropic substrate with a first x-direction optical axis and a second y-direction optical axis.

Preferably, the wide-viewing-angle liquid crystal panel further includes a first transparent electrode mounted between the first surface and the first alignment film.

Preferably, the first transparent electrode is a transparent electric conducting thin film.

Preferably, the transparent electrode is made of a metal oxide.

Preferably, the wide-viewing-angle liquid crystal panel further includes a second transparent electrode mounted between the third surface and the second alignment film.

Preferably, the first transparent electrode is a transparent electric conducting thin film which is made of a metal oxide.

Preferably, the wide-viewing-angle liquid crystal panel further includes a color filter mounted between the first wide-viewing-angle substrate and the liquid crystal layer.

Preferably, the wide-viewing-angle liquid crystal panel further includes a thin-film transistor layer mounted on the third surface of the second wide-viewing-angle substrate.

Preferably, the first and the second alignment films are made of polyimide.

Preferably, the first and the second polarizers are made by respectively mounting triacetylcellulose (TAC) films on two surfaces of an extended polyvinyl alcohol (PVA) substrate.

In accordance with another aspect of the present invention, another liquid crystal display panel is provided. The liquid crystal display panel includes a first wide-viewing-angle substrate having a first surface and a second surface, a second wide-viewing-angle substrate having a third surface and a fourth surface, and a liquid crystal layer, wherein the first wide-viewing-angle substrate and the second wide-viewing-angle substrate are so positioned that the first surface is near the third surface than the second surface, and the liquid crystal layer is placed therebetween.

Preferably, the wide-viewing-angle liquid crystal display panel further includes a first alignment film mounted on the first surface.

Preferably, the wide-viewing-angle liquid crystal display panel further includes a second alignment film mounted on the third surface.

Preferably, the wide-viewing-angle liquid crystal display panel further includes a first polarizer mounted on the second surface.

Preferably, the liquid crystal display panel further includes a second polarizer mounted on the fourth surface.

The foregoing and other features and advantages of the present invention will be more clearly understood through the following descriptions with reference to the drawings, wherein:

### BRIEF DESCRIPTION OF THE DRAWING

FIG. 1 is a diagram showing the structure of the LCD panel manufactured by TN+Film technology according to the prior art.

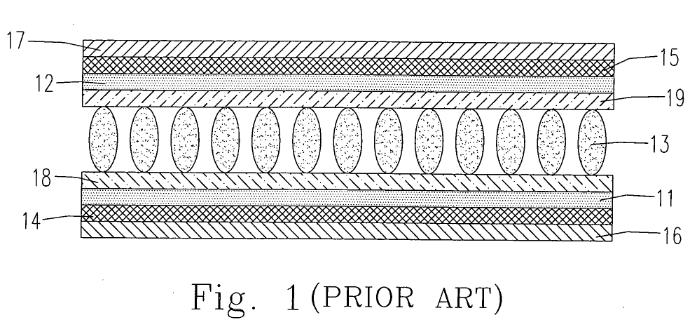

FIG. 2 is a diagram showing the structure of the LCD panel according to a preferred embodiment of the present invention; and

FIG. 3 is a diagram showing the structure of the LCD panel according to a further preferred embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

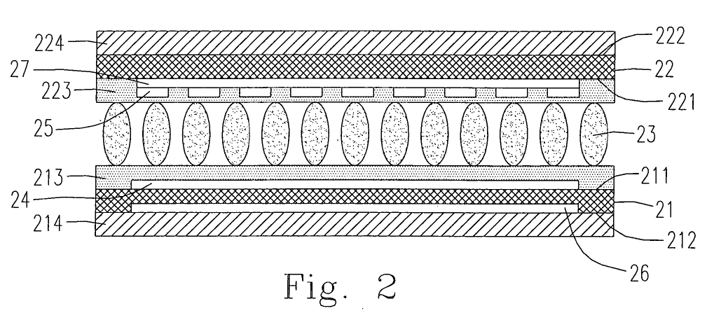

Please refer to FIG. 2, which is a diagram showing the structure of the LCD panel according to a preferred embodiment of the present invention. The wide-viewing-angle liquid crystal display panel includes the first wide-viewing-angle substrate 21, the first alignment film 213, the first polarizer 214, the second wide-viewing-angle substrate 22, the second alignment film 223, the second polarizer 224, and the liquid crystal layer 23. The first wide-viewing-angle substrate 21 has the first surface 211 and the second surface 212 and the second wide-viewing-angle substrate 22 has the third surface 221 and the fourth surface 222. The first and second alignment films 213 and 223 are mounted on the first and third surfaces 211 and 221, respectively. The first polarizer 214 is mounted on the second surface 212 and the second polarizer 224 is mounted on the fourth surface 222. The first wide-viewing-angle substrate 21 and second wide-viewing-angle substrate 22 are so positioned that the first surface 211 is near the third surface 221 than the second surface 212, and the liquid crystal layer 23 is placed therebetween. The first and second wide-viewing-angle substrates 21, 22 are flexible plastic substrates with extendable and wide-viewing-angle effects. The first and second wide-viewing-angle substrates 21, 22 are wide-viewing-angle substrates with double optical axes, respectively. The first and second wide-viewing-angle substrates 21, 22 further includes an in-plan retardation value (Ro) ranged between 0 and 400 nm and an out-of-plan retardation value (Rth) ranged between 0 and 300 nm, respectively. That is to say, the first and second wide-viewing-angle substrates 21, 22 are anisotropic substrates with a first x-direction optical axis and a second y-direction optical axis, respectively. In other words, the wide-viewing-angle substrate according to the present invention is equal to the substrate with the retardation film according to the prior art in functions. In addition, since the wide-viewing-angle substrate is made of the flexible and extendable material, it is able to be applied to many other applications. Therefore, the glass substrate or the plastic substrate with the polarizer in the prior art could be completely replaced by the polarized substrate according to the present invention.

Practically, the wide-viewing-angle liquid crystal display panel further includes the first transparent electrode 24 and the second transparent electrode 25. The first transparent electrode 24 is a transparent electric conducting thin film made of the metal oxides mounted between the first surface 211 and the first alignment film 213. Also, the second transparent electrode 25 is a transparent electric conducting thin film made of the metal oxides mounted between the third surface 211 and the second alignment film 213. The wide-viewing-angle liquid crystal display panel further includes the color filter 26 which is mounted between the first wide-viewing-angle substrate 21 and the liquid crystal layer 23. When the wide-viewing-angle liquid crystal display panel is applied to the TFT-LCD, the wide-viewing-angle liquid crystal display panel further includes the thin-film transistor layer 27 which is mounted on the third surface 221 of the second wide-viewing-angle substrate 22 for controlling the motion of the liquid crystals. Moreover, the first and second alignment films 213, 223 made of polyimide resins are used for aligning the liquid crystals before the electric field is applied thereto. For example, the rows of grooves printed by roller printing method are applied to arrange the liquid crystals in the grooves in the same direction. The first polarizer 214 and the second polarizer 224 are made by mounting a TAC film on both sides of a PVA extended substrate, respectively. The polarizers 214 and 224 only permit some specific oriented lights passing through them. For example, practically, the first and second polarizers 214, 224 are placed interlacedly and driven by the electric field for displaying the characters and the patterns.

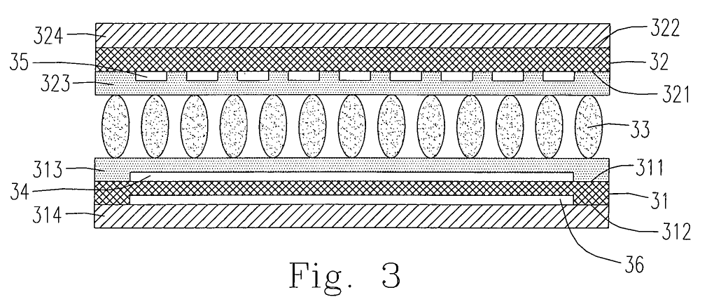

Please refer to FIG. 3, which is a diagram showing the structure of the LCD panel according to a further preferred embodiment of the present invention. The liquid crystal display panel includes the first wide-viewing-angle substrate 31, the second wide-viewing-angle substrate 32, and the liquid crystal layer 33. The first wide-viewing-angle substrate 31 has the first surface 311 and the second surface 312, and the second wide-viewing-angle substrate 32 has the third surface 321 and the fourth surface 322. The first wide-viewing-angle substrate 31 and the second wide-viewing-angle substrate 32 are so positioned that the first surface 311 is near the third surface 321 than the second surface 312, and the liquid crystal layer 33 is placed therebetween. Certainly, one of the features of the present invention is to use the wide-viewing-angle substrate for replacing the glass substrate or the plastic substrate according to the prior art. The wide-viewing-angle substrates 31, 32 are both flexible plastic substrates with extendable and wide-viewing-angle effects. The first and second wide-viewing-angle substrates 31, 32 are wide-viewing-angle substrates with double optical axes, respectively. The first and second wide-viewing-angle substrates 31, 32 further includes an in-plan retardation value (Ro) ranged between 0 and 400 nm and an out-of-plan retardation value (Rth) ranged between 0 and 300 nm, respectively. In other words, the basic structure of the LCD according to the present invention includes the wide-viewing-angle substrates 31, 32 and the liquid crystal layer 33 therebetween. Therefore, it is possible to replace the conventional LCD completely with the liquid crystal display panel having the wide-viewing-angle substrates which are made of extendable and flexible plastic materials according to the present invention.

Practically, the wide-viewing-angle liquid crystal display panel further includes the first and second transparent electrodes 34, 35. The first transparent electrode 34 is mounted between the first surface 311 and the first alignment film 313. The second transparent electrode 35 is mounted between the third surface 321 and the second alignment film 323. The first transparent electrode 34 is a transparent electric conducting thin film made of the metal oxides. Also, the second transparent electrode 35 is a transparent electric conducting thin film made of the metal oxides. The wide-viewing-angle liquid crystal display panel further includes the color filter 36 which is mounted between the first polarized substrate 31 and the liquid crystal layer 33. Moreover, the wide-viewing-angle liquid crystal display panel further includes the first alignment film 313 mounted on the first surface 311 and the second alignment film 323 mounted on the third surface 321. The first and second alignment films 313, 323 made of polyimide resins are used for aligning the liquid crystals before the electric field is applied thereto. For example, the rows of grooves printed by roller printing method are applied to arrange the liquid crystals in the grooves in the same direction.

The wide-viewing-angle liquid crystal display panel further includes the first polarizer 314 mounted on the second surface 312 and the second polarizer 324 mounted on the fourth surface 322. The first and second polarizers 314, 324 are made by mounting a TAC film on both sides of a PVA extended substrate, respectively. The polarizers 314 and 324 only permit some specific oriented lights passing through them. For example, practically, the first and second polarizers 314, 324 are placed interlacedly and driven by the electric field for displaying the characters and the patterns. Since the thickness of the LCD having the liquid crystal display panel of the present invention is lower than that of the LCD according to the prior art, the transmission distance is shorter and the loss of the light is less. Therefore, the image quality displayed on the LCD is better than that of the LCD having the glass substrate or the plastic substrate with the retardation film according to the prior art.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. A wide-viewing-angle liquid crystal panel, comprising:
a first wide-viewing-angle substrate having a first surface and a second surface;
a first alignment film mounted on said first surface;
a first polarizer mounted on said second surface;
a second wide-viewing-angle substrate having a third surface and a fourth surface,
a second alignment film mounted on said third surface;
a second polarizer mounted on said fourth surface; and
a liquid crystal layer,
wherein said first wide-viewing-angle substrate and said second wide-viewing-angle substrate are so positioned that said first surface is near said third surface than said second surface, and said liquid crystal layer is placed therebetween.

2. The wide-viewing-angle liquid crystal panel according to claim 1 wherein said first and said second wide-viewing-angle substrates are flexible plastic substrate with extendable and wide-viewing-angle effects.

3. The wide-viewing-angle liquid crystal panel according to claim 1 wherein said first and said second wide-viewing-angle substrates are wide-viewing-angle substrates with double optical axes, respectively.

4. The wide-viewing-angle liquid crystal panel according to claim 3 wherein said wide-viewing-angle substrate with double optical axes further comprises an in-plan retardation value (Ro) and an out-of-plan retardation value (Rth).

5. The wide-viewing-angle liquid crystal panel according to claim 4 wherein said Ro is ranged between 0 and 400 nm.

6. The wide-viewing-angle liquid crystal panel according to claim 4 wherein said Rth is ranged between 0 and 300 nm.

7. The wide-viewing-angle liquid crystal panel according to claim 3 wherein said wide-viewing-angle substrate with double optical axes is an anisotropic substrate with a first x-direction optical axis and a second y-direction optical axis.

8. The wide-viewing-angle liquid crystal panel according to claim 1 further comprising a first transparent electrode mounted between said first surface and said first alignment film.

9. The wide-viewing-angle liquid crystal panel according to claim 8 wherein said first transparent electrode is a transparent electric conducting thin film.

10. The wide-viewing-angle liquid crystal panel according to claim 8 wherein said transparent electrode is made of a metal oxide.

11. The wide-viewing-angle liquid crystal panel according to claim 1 further comprising a second transparent electrode mounted between said third surface and said second alignment film.

12. The wide-viewing-angle liquid crystal panel according to claim 11 wherein said first transparent electrode is a transparent electric conducting thin film which is made of a metal oxide.

13. The wide-viewing-angle liquid crystal panel according to claim 1 further comprising a color filter mounted between said first wide-viewing-angle substrate and said liquid crystal layer.

14. The wide-viewing-angle liquid crystal panel according to claim 1 further comprising a thin-film transistor layer mounted on said third surface of said second wide-viewing-angle substrate.

15. The wide-viewing-angle liquid crystal panel according to claim 1 wherein said first and said second alignment films are made of polyimide.

16. The wide-viewing-angle liquid crystal panel according to claim 1 wherein said first and said second polarizers are made by respectively mounting triacetylcellulose (TAC) films on two surfaces of an extended polyvinyl alcohol (PVA) substrate.

17. A wide-viewing-angle liquid crystal panel, comprising:
a first wide-viewing-angle substrate having a first surface and a second surface;
a second wide-viewing-angle substrate having a third surface and a fourth surface; and
a liquid crystal layer,
wherein said first wide-viewing-angle substrate and said second wide-viewing-angle substrate are so positioned that said first surface is near said third surface than said second surface, and said liquid crystal layer is placed therebetween.

18. The wide-viewing-angle liquid crystal panel according to claim 17 further comprising a first alignment film mounted on said first surface.

19. The wide-viewing-angle liquid crystal panel according to claim 17 further comprising a second alignment film mounted on said third surface.

20. The wide-viewing-angle liquid crystal panel according to claim 17 further comprising a first polarizer mounted on said second surface.

21. The wide-viewing-angle liquid crystal panel according to claim 17 further comprising a second polarizer mounted on said fourth surface.
